(19) United States
(12) Patent Application Publication
(10) Pub. No.: US 2006/0098222 A1
(43) Pub. Date: May 11, 2006

(54) Image forming device

(75) Inventor: Masaki Tachibana, Koga-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/246,616

(22) Filed: Oct. 7, 2005

(30) Foreign Application Priority Data
Nov. 8, 2004 (JP) 2004-323457
Nov. 24, 2004 (JP) 2004-339509

(51) Int. Cl. G06K 15/00

(52) U.S. Cl. 358/1.14

(57) ABSTRACT

An image forming device includes a receiving unit, a generating unit, a forming unit, a detecting unit and an error information generating unit. The receiving unit receives print data and device information relating to a remote device from the remote device. The generating unit generates image data from the print data received by the receiving unit. The forming unit forms an image based on the image data generated by the generating unit onto a recording medium. The detecting unit detects a generation of a print error based on the print data received by the receiving unit. When the detecting unit detects the generation of the print error, the error information generating unit generates error information including the received device information and information relating to the detected print error.

### BACKGROUND OF THE INVENTION

1. Field of the Invention

The present invention relates to an image forming device, which generates error information when a print error generates, wherein the error information includes the generated print error (a command error) and device information indicating a remote device that transmitted print data, which caused the print error. The present invention also relates to an image forming device, which forms an image onto paper when a command error (a print error) generates in accordance with text data previously prepared for the generated command error.

2. Description of Related Art

A widespread image forming device, such as a printer and a facsimile multifunction peripheral, is used by being connected to an information processing device like a personal computer via a Local Area Network (LAN) or the like. By connecting the information processing device and the image forming device as described above, the image forming device can be shared by a plurality of information processing devices, and hardware resources can be utilized efficiently. Print data based on a document, a graphics or the like, which has been created by the information processing device, is transmitted to the image forming device. The image forming device analyzes a command included in the print data received from the information processing device, and generates image data for an image output process. Then, the image forming device carries out an image forming process in accordance with the generated image data.

When generating the image data for the image output process from the print data received from the information processing device, there are cases in which a certain command error generates, and the image forming device cannot generate appropriate image data. In such cases, the image forming device creates an error report indicating a type of the generated error, and forms an image onto paper according to necessity. Accordingly, a manager of the image forming device can grasp the type of the generated error.

Although the type of the generated error can be grasped from the above-described error report, for example, it is difficult to specify from which information processing device the print data that generated the error has been transmitted.

In the above-described image forming device, there are cases in which exclusive software is used to realize a structure for creating an error report when a command error generates. In such cases, there is a drawback that a storage capacity is required to be secured for storing the software for creating an error report. Furthermore, the software is required to be tested and debugged in a manufacturing process, and a long period of time is taken for the test and the debug.

Meanwhile, a known facsimile machine prints out an error report in case an error generates when data received by facsimile is transferred to a host device connected via a network. The error report printed out by such a facsimile machine includes a type of the generated error and host information indicating the host device of a transfer destination of the data. The facsimile machine can only grasp the host information of the transfer destination, which an error generated when the data is transferred. That is, for an error that generates during a processing based on the data received from a remote device, the facsimile machine cannot specify a device of the transmitter of the data that caused the error.

### SUMMARY OF THE INVENTION

The present invention has been made in consideration of the above-described circumstances. A first advantage of the present invention is to provide an image forming device, wherein in case a print error (a command error) generates when carrying out an image forming process based on print data received from a remote device, the image forming device can specify (grasp) a type of the generated print error and the remote device, which transmitted the print data that caused the print error.

A second advantage of the present invention is to provide an image forming device, which does not require an exclusive structure for creating an error report, wherein in case a command error (a print error) generates when carrying out an image forming process based on data received from a remote device, the image forming device can form an image based on text data corresponding to the generated command error onto a recording medium by a normal image forming process.

To accomplish the first advantage of the present invention, according to an aspect of the present invention, an image forming device includes a receiving unit, a generating unit, a forming unit, a detecting unit and an error information generating unit. The receiving unit receives print data and device information relating to a remote device from the remote device. The generating unit generates image data from the print data received by the receiving unit. The forming unit forms an image based on the image data generated by the generating unit onto a recording medium. The detecting unit detects a generation of a print error based on the print data received by the receiving unit. When the detecting unit detects the generation of the print error, the error information generating unit generates error information including the device information received by the receiving unit and information relating to the print error detected by the detecting unit.

According to the above-described aspect, the image forming device receives the print data from the remote device, generates the image data from the received print data, and forms an image based on the generated image data onto the recording medium. The image forming device receives the print data and the device information relating to the remote device from the remote device. When a print error based on the received print data generates, the image forming device generates error information including the received device information and the information relating to the generated print error. Therefore, when a print error generates, the type of the generated print error and the remote device, which transmitted the print error that caused the print error, can be specified.

According to another aspect of the present invention, the image forming device includes a storage unit and a deleting unit. The storage unit stores the device information received by the receiving unit. After the generating unit generates the image data, the deleting unit deletes the device information corresponding to the print data, which has been used for generating the image data, from the storage unit. In this case, when the detecting unit detects the generation of the print error, the error information generating unit generates error information including the device information stored in the storage unit and the information relating to the print error detected by the detecting unit.

According to the above-described aspect, the device information received along with the print data from the remote device is stored into the storage unit, and after the image data is generated from the print data, the corresponding device information is deleted from the storage unit. Therefore, when the image data is generated appropriately from the received print data, by deleting the corresponding device information from the storage unit, unnecessary device information is deleted and a memory capacity can be saved. When image data fails to be generated appropriately from the received print data and a print error generates, error information can be generated by using the device information stored in the storage unit.

According to another aspect of the present invention, the image forming device includes a data storage unit. The data storage unit stores the image data generated by the generating unit. In this case, the forming unit fetches the image data stored in the data storage unit from the data storage unit, and forms an image based on the fetched image data.

According to the above-described aspect, the image data generated from the received print data by the generating unit is stored into the data storage unit, the stored image data is fetched from the data storage unit, and an image based on the fetched image data is formed. Since the image data generated from the print data is not input directly to the forming unit, which forms an image based on the image data, even when the forming unit is replaced, a configuration of the generating unit is not required to be changed.

To accomplish the second advantage of the present invention, according to an aspect of the present invention, an image forming device includes a receiving unit, a generating unit, a forming unit, a detecting unit and a storage unit. The receiving unit receives data having a command relating to an image forming process from a remote device. The generating unit analyzes the command included in the data received by the receiving unit and generates image data. The forming unit forms an image based on the image data generated by the generating unit onto a recording medium. The detecting unit detects a generation of a command error while the command is being analyzed by the generating unit. The storage unit stores text data corresponding to each of a plurality of command errors. When the detecting unit detects the generation of the command error, the forming unit forms an image based on the text data stored in the storage unit by being associated with the detected command error.

According to the above-described aspect, the image forming device receives the data having the command relating to the image forming process from the remote device, analyzes the command included in the received data, generates the image data, and forms an image based on the generated image data onto the recording medium. The image forming device previously stores text data corresponding to each of a plurality of command errors in the storage unit. When the command error generates while the command included in the received data is being analyzed, the image forming device forms an image based on the text data stored in the storage unit by being associated with the generated command error. Therefore, when the command error generates, an image based on the text data corresponding to the generated command error is formed onto the recording medium by a normal image forming process. Accordingly, an exclusive configuration for creating an error report becomes unnecessary, and processes such as a test and a debug can be omitted for such an exclusive configuration that has become unnecessary. As a result, a manufacturing process can be shortened.

According to another aspect of the present invention, the image forming device includes a data storage unit and a storing processing unit. The data storage unit stores the data received by the receiving unit. When the detecting unit detects the generation of the command error, the storing processing unit carries out a processing for storing text data corresponding to the detected command error into the data storage unit. In this case, the generating unit sequentially fetches the data stored in the data storage unit, and generates image data from the fetched data.

According to the above-described aspect, the image forming device includes the data storage unit, which stores the data received from the remote device. The image forming device sequentially fetches the data stored in the data storage unit, generates the image data from the fetched data, and carries out the image forming process. When the command error generates, by storing the text data corresponding to the generated command error into the data storage unit, an image forming process of the text data corresponding to the command error can be carried out by the same processing as the normal image forming process. As a result, an exclusive configuration for creating an error report becomes unnecessary.

According to the another aspect of the present invention, when the detecting unit detects the generation of the command error, the generating unit can skip the data relating to such a command error stored in the data storage unit.

According to the above-described aspect, when the command error generates, by skipping the data relating to the generated command error among the data stored in the data storage unit, an exclusive processing carried out accompanying the generation of the command error becomes unnecessary. Therefore, the test and the debug or the like can be carried out on the processing for detecting the generation of the command error in the manufacturing process. As a result, a manufacturing process can be shortened.

According to another aspect of the present invention, the storing processing unit can carry out a processing for storing the text data corresponding to the command error detected by the detecting unit into a top fetching area of the data storage unit.

According to the above-described aspect, when the command error generates, by storing the text data corresponding to the generated command error into the top fetching area of the data storage unit, an image forming process of the text data corresponding to the command error can be carried out with preference to other data stored already in the data storage unit. As a result, the generation of the command error can be notified to a remote device at an early stage.

According to another aspect of the present invention, in the image forming device, the receiving unit is configured to receive the data having the command and the device information relating to the remote device. The image forming device further includes an adding unit. When the detecting unit detects the generation of the command error, the adding unit adds the device information received by the receiving unit to the text data corresponding to the detected command error. In this case, when the detecting unit detects the generation of the command error, the storing processing unit can carry out a processing for storing the text data added with the device information by the adding unit into the data storage unit.

According to the above-described aspect, the image forming device receives the data having the command and the device information relating to the remote device from the remote device. When the command error generates, the received device information is added to the text data corresponding to the generated command error and stored into the data storage unit. The image forming device sequentially fetches the data stored in the data storage unit, generates image data from the fetched data, and forms an image based on the generated image data. Therefore, the comment corresponding to the generated command error and the remote device, which transmitted the data that caused the command error, can be grasped from the image of the text data.

### BRIEF DESCRIPTION OF THE DRAWINGS

FIG. 1 is a block diagram illustrating an example of a configuration of an image forming device according to a first embodiment of the present invention.

FIG. 2 is a view illustrating an example of a configuration of an error report according to the first embodiment of the present invention.

FIG. 3 is a flowchart of an image processing procedure carried out by a Printer Control Language (PCL) controller according to the first embodiment of the present invention.

FIG. 4 is a block diagram illustrating an example of a configuration of an image forming device according to a second embodiment of the present invention.

FIG. 5 is a view illustrating an example of a configuration of an error report according to the second embodiment of the present invention.

FIG. 6 is a flowchart of an image processing procedure carried out by a PCL controller according to the second embodiment of the present invention.

### DETAILED DESCRIPTION OF THE PREFERRED EMBODIMENTS

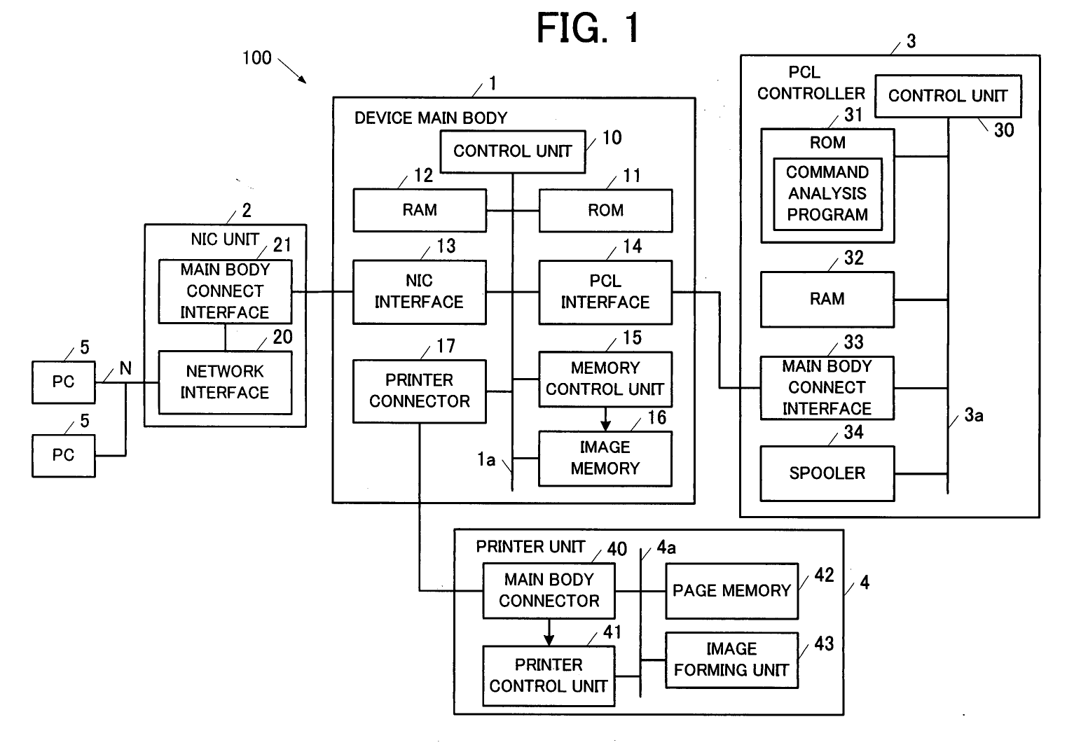

(First Embodiment) With reference to the drawings (FIG. 1 through FIG. 3), a first embodiment of the present invention will be described. FIG. 1 is a block diagram illustrating an example of a configuration of an image forming device according to the first embodiment of the present invention. An image forming device 100 according to the first embodiment includes a Network Interface Controller (NIC) unit 2, a PCL controller 3, a printer unit 4 and a device main body 1. The NIC unit 2 is connected to a communication network N, such as a LAN. The PCL controller 3 converts print data received by the communication network N into image data for carrying out an image forming process. The printer unit 4 carries out an image forming process based on the image data generated by the PCL controller 3. The device main body 1 connects the NIC unit 2, the PCL controller 3 and the printer unit 4.

The NIC unit 2 of the image forming device 100 includes a network interface 20, which can establish a connection with the communication network N, and a main body connect interface 21, which can establish a connection with the device main body 1. The NIC unit 2 receives via the network interface (receiving unit) 20, print data based on a document, a graphics or the like created by remote computers (hereinafter “PCs”) 5 and 5 connected to the communication network N. The NIC unit 2 transfers the print data, which has been received from the PCs (the remote devices) 5 and 5, from the main body connect interface 21 to the device main body 1.

The device main body 1 includes a control unit 10, a Read Only Memory (ROM) 11, a Random Access Memory (RAM) 12, a NIC interface 13, a PCL interface 14, a memory control unit 15, an image memory 16 and a printer connector 17 as main components. Each of the main components is connected to one another via a system bus 1a. The control unit 10is formed of a Central Processing Unit (CPU) or a Micro Processor Unit (MPU) or the like. The NIC interface 13 establishes a connection with the NIC unit 2. The PCL interface 14 establishes a connection with the PCL controller 3. The printer connector 17 establishes a connection with the printer unit 4.

The control unit 10 controls each of the above-mentioned hardware components of the device main body 1 connected via the system bus 1. The control unit 10 executes a software function in accordance with various control programs stored in the ROM 11. The RAM 12 is formed of a Static RAM (SRAM) or a flash memory or the like. The RAM 12 temporarily stores data that generates when a control program is executed by the control unit 10.

The device main body 1 transfers the print data, which has been obtained from the NIC interface 13, from the PCL interface 14 to the PCL controller 3. The print data received via the communication network N includes data, which is to be executed with an image forming process to form an image onto paper, and a command, which indicates various instructions for appropriately carrying out the image forming process of the data. The PCL controller 3 analyzes the command included in the print data obtained from the device main body 1, and converts the print data into image data (raster data) of a format, which can be formed into an image by the printer unit 4. Then, the PCL controller 3 returns the converted image data to the device main body 1. Consequently, the device main body 1 stores the image data, which has been obtained from the PCL controller 3 via the PCL interface 14, into the image memory (data storage unit) 16 by the memory control unit 15. Then, the control unit 10 fetches the image data from the image memory 16 under a prescribed timing, and transfers the image data from the printer connector 17 to the printer unit 4.

The printer unit 4 includes a main body connector 40, a printer control unit 41, a page memory 42 and an image forming unit 43 or the like as main components. Each of the main components is connected to one another via a system bus 4a. The main body connector 40 establishes a connection with the device main body 1. The printer control unit 41 stores the image data transmitted from the device main body 1 into the page memory 42 once, and inputs the image data to the image forming unit 43 per each page. The image forming unit 43 is a forming unit, which forms an image based on the image data input from the page memory 42 onto paper (recording medium). Further, a printer device of an electrophotographic method, an inkjet method, a thermal transfer method, a sublimation method or the like may be used for the image forming unit 43.

The PCL controller 3 includes a control unit 30, a ROM 31, a RAM 32, a main body connect interface 33 and a spooler 34 or the like as main components. Each of the main components is connected to one another via a system bus 3a. The control unit 30 is formed of a CPU or an MPU or the like having a clocking unit (not shown). The main body connect interface 33 establishes a connection with the device main body 1.

The control unit 30 controls each of the above-mentioned hardware components of the PCL controller 3 connected via the system bus 3a. The control unit 30 executes a software function in accordance with various control programs stored in the ROM 31. The RAM 32 is formed of a SRAM or a flash memory or the like. The RAM 32 temporarily stores data that generates when a control program is executed by the control unit 30. Further, the ROM 31 previously stores a command analysis program for expanding print data received from the remote PCs 5 and 5 via the communication network N and generating image data for the image forming process.

When the control unit 30 obtains the print data from the device main body 1 via the main body connect interface 33, the control unit 30 stores the print data into the spooler 34. The control unit 30 operates as a generating unit, which generates image data by fetching the command analysis program stored in the ROM 31 to the RAM 32 and executing the fetched command analysis program. The generating unit generates image data by executing the command analysis process on the print data fetched sequentially from the spooler 34. The generated image data is input sequentially to the device main body 1 from the main body connect interface 33, and stored into the image memory 16 by the memory control unit 15.

When the PCs 5 and 5 transmit print data via the communication network N, the PCs 5 and 5 also transmit data information (device information). Further, the data information includes PC information indicating a transmitter, user information indicating users of the PCs 5 and 5, and a file name specifying image data to be printed included in the print data. In the image forming device 100, the NIC unit 2, which received the data information along with the print data, transfers the received print information and the received data information to the device main body 1. The device main body 1 transfers the print data obtained from the NIC unit 2 directly to the PCL controller 3. The device main body 1 stores the data information in the RAM (storage unit) 12.

While the PCL controller 3 accumulates the print data obtained from the device main body 1 in the spooler 34, the PCL controller 3 generates image data by executing the command analysis process on the print data fetched from the spooler 34. Then, the PCL controller 3 transfers the generated image data to the device main body 1. The control unit 10 stores the image data obtained from the PCL controller 3 into the image memory 16. The control unit 10 determines whether or not the transfer of the image data corresponding to one print data from the PCL controller 3 has been completed in accordance with data communication carried out with the PCL controller 3. When the control unit 10 determines that the transfer of the image data corresponding to one print data has been completed, the control unit 10 deletes the data information corresponding to the print data from the RAM 12.

There are cases in which the print data received via the communication network N cannot be converted into image data by the PCL controller 3. For example, when the PC 5 selects a wrong printer driver and executes an image output process from the printer driver that is different from a printer driver supporting the image forming device 100, the control unit (detecting unit) 30 of the PCL controller 3 cannot analyze the command of the obtained print data. In this case, since the control unit 30 cannot generate image data, the control unit 30 detects that a print error has generated.

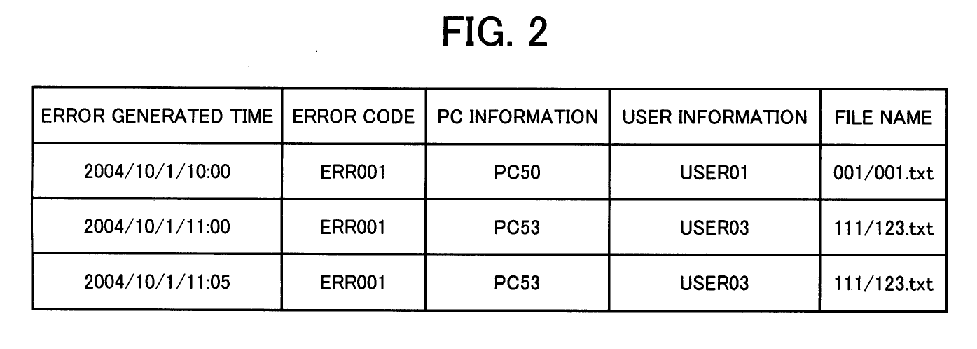

The control unit 30 operates as an error information generating unit. When the generation of the print error is detected, the error information generating unit obtains the data information stored in the RAM 12 of the device main body 1, and generates error information including the obtained data information and an error code indicating the generated print error. Further, the generated error information is stored once in the RAM 32 of the PCL controller 3, transferred to the printer unit 4 via the device main body 1 according to a preset timing, and output in a form of an image as an error report illustrated in FIG. 2.

The error report illustrated in FIG. 2 includes a generated time of a print error, an error code indicating a type of the generated print error, and PC information, user information and a file name or the like included in the data information. By outputting such an error report in the form of an image, the user can specify the type of the generated print error, and the PC 5 and the user of the transmitter of the print data that caused the print error. When the print data is converted into the image data appropriately without a generation of a print error, the data information for specifying the PC 5 and the user of the transmitter of the print data (the PC information, the user information and the file name) is deleted from the RAM 12 after the image data is generated. Accordingly, the RAM 12 can be utilized efficiently.

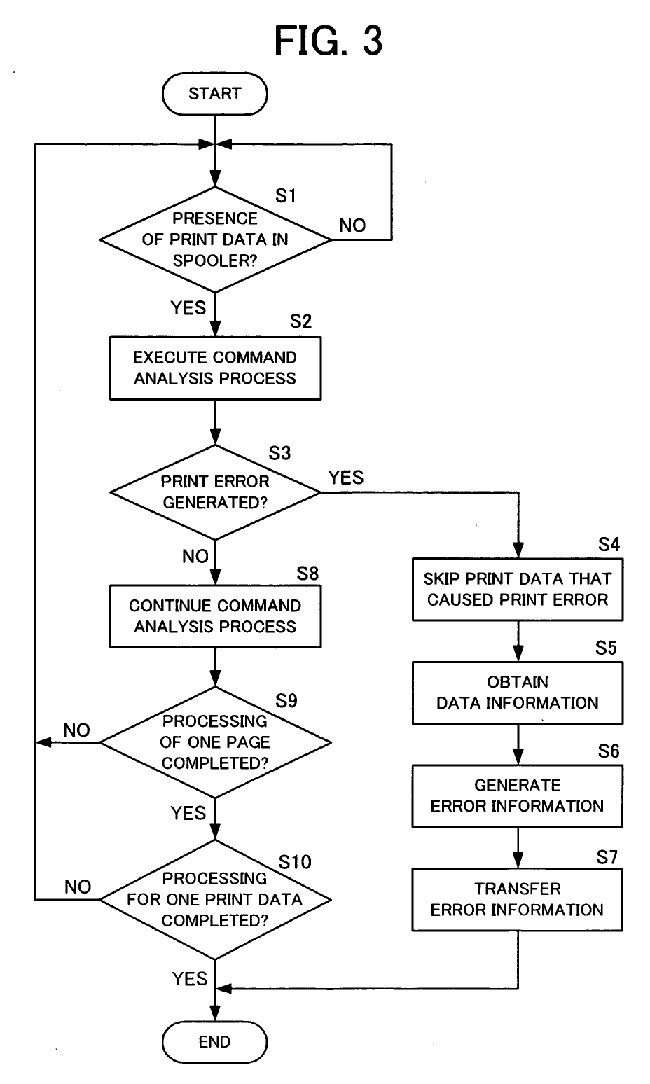

Next, a description will be made of an operation of the PCL controller 3 in the image forming device 100 described above. FIG. 3 is a flowchart illustrating an image processing procedure carried out by the PCL controller 3. Each process shown in FIG. 3 is executed by the control unit 30 of the PCL controller 3 in accordance with the control program stored previously in the ROM 31.

As described above, the image forming device 100 stores the print data, which has been received via the NIC unit 2 from the remote PCs 5 and 5 connected to the communication network N, into the spooler 34 of the PCL controller 3 via the device main body 1. The control unit 30 of the PCL controller 3 determines a presence or an absence of the print data in the spooler 34 (step S1). When a determination of an absence of the print data is made (step S1: NO), the control unit 30 goes on standby.

When the control unit 30 determines that the print data exists in the spooler 34 (step S1: YES), the control unit 30 fetches the command analysis program stored in the ROM 31 to the RAM 32 and executes the command analysis program. Accordingly, the command analysis process is executed on the print data fetched sequentially from the spooler 34 (step S2). The control unit 30 determines whether or nor a print error (for example, a printer driver error) has generated in the executed command analysis process (step S3). When the control unit 30 determines that the print error has generated (step S3: YES), the control unit 30 skips the print data that caused the print error (step S4). That is, for the print data stored in the spooler 34, the control unit 30 skips to an end of the print data (print job) that caused the print error. Thus, print data fetched from the spooler 34 next is print data relating to a next print job.

When the control unit 30 detects the generation of the print error, the control unit 30 obtains data information of the print data that caused the print error from the RAM 12 of the device main body 1 (step S5). The control unit 30 generates error information in accordance with an error generated time indicated by the clocking unit of the control unit 30, an error code of the generated print error and data information obtained from the device main body 1 (step S6). The control unit 30 transfers the generated error information to the printer unit 4 via the device main body 1 (step S7). The printer unit 4 outputs the error information onto paper as an error report illustrated in FIG. 2.

Meanwhile, when a determination is made at step S3 that a print error has not generated (step S3: NO), in other words, when the command analysis process can be executed on the print data fetched sequentially from the spooler 34 by the command analysis program executed by the control unit 30, the command analysis process is continued (step S8). The sequentially generated image data is transferred to the device main body 1 and stored into the image memory 16. Further, the control unit 10 of the device main body 1 transfers the image data, which has been transferred from the PCL controller 3 and stored into the image memory 16, to the printer unit 4 per each page.

The control unit 30 determines whether or not the command analysis process for the print data of one page has been completed (step S9). When a determination is made that the command analysis process for the data of one page has not been completed (step S9: NO), the process returns to the process of step S1. The print data stored in the spooler 34 is fetched, and the command analysis process is continued (step S2). When the control unit 30 determines that the command analysis process for the print data of one page has been completed (step S9: YES), the control unit 30 determines whether or not the command analysis process for one print data has been completed (step S10). When a determination is made that the command analysis process for one print data has not been completed (step S10: NO), the process returns to step S1, and the processes of step S1 through step S9 are repeated. When the control unit 10 determines that the command analysis process for one print data has been completed (step S10: YES), the above-described processes end.

In the above-described embodiment, a description is made of a configuration in which the device main body 1, the NIC unit 2, the PCL controller 3 and the printer unit 4 of the image forming device 100 are provided on different substrates as shown in FIG. 1. However, the device main body 1, the NIC unit 2, the PCL controller 3 and the printer unit 4 of the image forming device 100 may be provided on the same substrate. Moreover, the image data, which has been generated after the command analysis process carried out by the PCL controller 3, is stored once into the image memory 16 of the device main body 1. Then, the image data is fetched from the image memory 16 per each page, and transferred to the printer unit 4. Since the image data is not transferred directly from the PCL controller 3 to the printer unit 4, even when the printer unit 4 is changed, the change of the printer unit 4 can be supported just by a change made in the device main body 1. As a result, an advantageous effect that the PCL controller 3 is not required to be changed can be obtained.

In the above-described embodiment, a description is made of a configuration in which the print data and the data information are received via the communication network N, and the received data information is stored into the RAM 12 of the device main body 1. However, for example, the data information can be described in a Printer Job Language (PJL) written by a printer driver of the PC 5, and when the PJL is analyzed by the PCL controller 3, the data information can be obtained. That is, the data received by the PCL controller 3 can be analyzed to obtain the data information, and the obtained data information can be transferred and stored into the RAM 12 of the device main body 1. In this case, for example, also for the print data received via another input port, such as a parallel port and a Universal Serial Bus (USB) port, in other words, also for the print data received via another input port of the device main body 1 without being transferred through the NIC unit 2, the data information of each print data can be obtained, and an error report with the data information can be created.

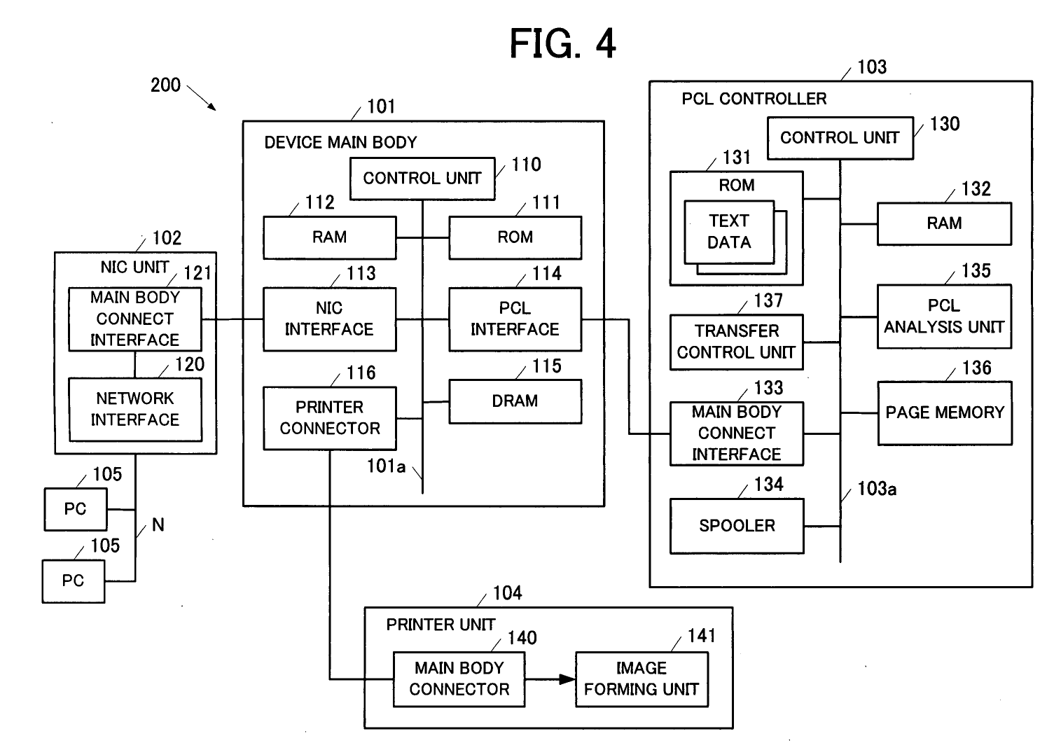

(Second Embodiment) Next, with reference to the drawings, a description will be made of a second embodiment of the present invention. FIG. 4 is a block diagram showing an example of a configuration of an image forming device according to the second embodiment of the present invention. An image forming device 200 of the second embodiment includes an NIC unit 102, a PCL controller 103, a printer unit 104 and a device main body 101. The NIC unit 102 is connected to a communication network N, such as the LAN. The PCL controller 103 converts print data (data) received via the communication network N into image data for carrying out an image forming process. The printer unit 104 carries out an image forming process based on the image data generated by the PCL controller 103. The device main body 101 connects the NIC unit 102, the PCL controller 103 and the printer unit 104. For example, the print data received via the communication network N is print data described by the PCL, and includes data, which is to be executed with an image forming process to form an image onto paper, and various commands, which indicate various instructions for appropriately carrying out the image forming process of the data.

The NIC unit 102 of the image forming device 200 includes a network interface 120 and a main body connect interface 121. The network interface 120 can establish a connection with the communication network N. The NIC unit 102 can establish a connection with the device main body 101. The NIC unit 102 receives, via the network interface (receiving unit) 120, print data based on a document, a graphics or the like created by remote computers (hereinafter “PCs”) 105 and 105 connected to the communication network N. The NIC unit 102 transfers the print data, which has been received from the PCs (remote devices) 105 and 105, from the main body connect interface 121 to the device main body 101.

The device main body 101 includes a control unit 110, a ROM 111, a RAM 112, a NIC interface 113, a PCL interface 114, a Dynamic RAM (DRAM) 115 and a printer connector 116 or the like as main components. Each of the main components is connected to one another via a system bus 101a. The control unit 110 is formed of a CPU or an MPU or the like. The NIC interface 113 establishes a connection with the NIC unit 102. The PCL interface 114 establishes a connection with the PCL controller 103. The printer connector 116 establishes a connection with the printer unit 104.

The control unit 110 controls each of the above-mentioned hardware components of the device main body 101 connected via the system bus 101a. The control unit 111 executes a software function in accordance with various control programs stored in the ROM 111. The RAM 112 is formed of a SRAM or a flash memory or the like. The RAM 112 temporarily stores data that generates when a control program is executed by the control unit 110.

Further, the device main body 101 transfers the print data, which has been obtained from the NIC interface 113, from the PCL interface 114 to the PCL controller 103. The PCL controller 103 analyzes a command included in the print data obtained from the device main body 101. The PCL controller 103 converts the print data into image data (raster data) of a format, which can be formed into an image by the printer unit 104. Then, the PCL controller 103 returns the converted image data to the device main body 101. Consequently, the device main body 101 stores the image data, which has been obtained from the PCL controller 103 via the PCL interface 114, into the DRAM 115. Then, the control unit 110 fetches the image data from the DRAM 115 under a prescribed timing, and transfers the image data from the printer connector 116 to the printer unit 104.

The printer unit 104 includes a main body connector 140 for establishing a connection with the device main body 101, and an image forming unit 141. The printer unit 104 sequentially inputs the image data transmitted from the device main body 101 via the main body connector 140 into the image forming unit 141. The image forming unit 141 is a forming unit, which forms an image based on the input image data onto paper (recording medium). Further, a printer device of an electrophotographic method, an inkjet method, a thermal transfer method, a sublimation method or the like may be used for the image forming unit 141.

The PCL controller 103 includes a control unit 130, a ROM 131, a RAM 132, a main body connect interface 133, a spooler 134, a PCL analysis unit 135, a page memory 136 and a transfer control unit 137 or the like as main components. Each of the main components is connected to one another via a system bus 103a. The control unit 130 is formed of a CPU or an MPU or the like having a clocking unit (not shown). The main body connect interface 133 establishes a connection with the device main body 1.

The control unit 130 controls each of the above-mentioned hardware components of the PCL controller 103 connected via the system bus 103a. The control unit 130 executes a software function in accordance with various control programs stored in the ROM 131. The RAM 132 is formed of an SRAM or a flash memory or the like. The RAM 132 temporarily stores data that generates when a control program is executed by the control unit 130.

When the control unit 130 obtains print data from the device main body 101 via the main body connect interface 133, the obtained print data is stored into the spooler (data storage unit) 134. The PCL analysis unit 135 operates as a generating unit, which generates image data for an image forming process by sequentially fetching the print data stored in the spooler 134 per each command and carrying out an analysis process of each fetched command. The generating unit generates image data for one image forming process from one print data. The generated image data is stored sequentially into the page memory 136, and transferred from the main body connect interface 133 to the device main body 101 per each page in accordance with a control of the transfer control unit 137. Then, the image data is stored into the DRAM 115 of the device main body 101.

The image forming device 200 is configured to carry out an image forming process also on text data received from the PCs 105 and 105 via the communication network N. Further, when the PCs 105 and 105 transmit the text data to be processed to the image forming device 200, the PCs 105 and 105 transmit the text data directly without using a printer driver used for transmitting the print data. In the same manner, as when receiving the print data, the image forming device 200, which received the text data from the PCs 105 and 105, stores the received text data into the spooler 134 of the PCL controller 103.

The above-described PCL format print data includes a control command indicating that the print data is PCL format print data at a top part of the print data. When the control command is detected from the top of the data fetched from the spooler 134 for carrying out the image forming process, the control unit 130 of the PCL controller 103 determines that the data is the PCL format print data. When the control command fails to be detected, the control unit 130 determines that the data is text data. That is, the control unit 130 determines whether the data to be processed is the print data or the text data in accordance with a presence or an absence of the control command at the top of the data fetched from the spooler 134.

When the control unit 130 determines that the data fetched from the spooler 134 is the text data, the command analysis process by the PCL analysis unit 135 is not carried out. The control unit 130 converts the text data fetched from the spooler 134 into image data (raster data), and sequentially stores the converted image data into the page memory 136. In accordance with a control by the transfer control unit 137, the image data stored into the page memory 136 is transferred from the main body connect interface 133 to the device main body 101 per each page, and stored into the DRAM 115 of the device main body 101. Furthermore, the image data stored in the DRAM 115 is transferred sequentially to the printer unit 104, and an image is formed onto paper.

The control unit 130 of the PCL controller 103 includes a flag indicating whether or not data currently being processed is print data. When the data fetched from the spooler 134 is the print data, the flag is set ON. When the data fetched from the spooler 134 is the text data, the flag is set OFF. Therefore, the control unit 130 can grasp whether the data fetched sequentially from the spooler 134 is the print data or the text data in accordance with the state of the flag. According to necessity, the control unit 130 can execute the command analysis process by the PCL analysis unit 135.

When the PCs 105 and 105 transmit the print data via the communication network N, the PCs 105 and 105 also transmit data information (device information). For example, the data information includes PC information indicating a transmitter, user information indicating a user of the PCs 105 and 105, and a file name specifying image data to be printed included in the print data. In the image forming device 200, the NIC unit 102, which received the data information along with the print data, transfers the received print data and the received data information to the device main body 101. The device main body 101 transfers the print data obtained from the NIC unit 102 directly to the PCL controller 103, and stores the data information in the RAM 112.

While the PCL controller 103 accumulates the print data obtained from the device main body 101 in the spooler 134, the PCL controller 103 fetches the print data accumulated in the spooler 134 per each prescribed unit. The PCL controller 103 executes the command analysis process by the PCL analysis unit 135 on the fetched print data, and generates image data. The PCL controller 103 transfers the generated image data stored in the page memory 136 to the device main body 101 by the transfer control unit 137. The control unit 110 of the device main body 101 sequentially stores the image data obtained from the PCL controller 103 into the DRAM 115. In accordance with the data communication carried out with the PCL controller 103, the control unit 110 determines whether or not the transfer of the image data corresponding to one print data from the PCL controller 103 has been completed. When the control unit 110 determines that the transfer of the image data corresponding to one print data has been completed, the control unit 110 transfers the image data stored in the DRAM 115 to the printer unit 104.

There are cases in which the print data received via the communication network N cannot be converted into image data by the PCL controller 103. For example, when the user of the PC 105 selects a wrong printer driver and executes an image output process from the printer driver that is different from a printer driver supporting the image forming device 200, the control unit (detecting unit) 130 of the PCL controller 103 cannot analyze the command included in the obtained print data by the PCL analysis unit 135. In this case, since the image data cannot be generated, the control unit 130 detects that a command error has generated.

The ROM (storage unit) 131 of the PCL controller 103 stores message data by associating with an error code indicating each command error. The message data is text data in which a message corresponding to each command error is described. When the control unit 130 detects a generation of a command error, the control unit 130 fetches message data associated with an error code of the generated command error from the ROM 131 to the RAM 132, and obtains the data information stored in the RAM 112 of the device main body 101. Then, the control unit (adding unit) 130 operates as a storing processing unit, which adds the obtained data information to the fetched message data in the RAM 132 and stores the message data added with the data information into the spooler 134.

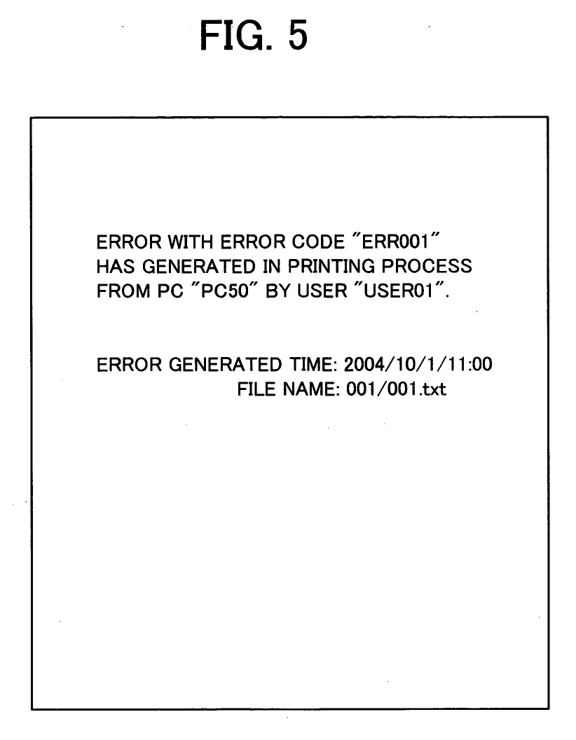

When the control unit 130 determines that the message data stored in the spooler 134 is the text data in the same manner as the text data received from the PCs 105 and 105 via the communication network N and stored in the spooler 134, the message data is fetched sequentially from the spooler 134 and converted into image data. The converted image data is stored once in the page memory 136 and transferred to the printer unit 104 via the device main body 101. Then, the image data is output in a form of an image as an error report illustrated in FIG. 5. Further, when storing the text data added with the data information into the spooler 134, by storing the text data into a top fetching area of the spooler 134, an image output process of the error report can be carried out with preference to other print data stored already in the spooler 134.

Regarding the generated command error, the error report illustrated in FIG. 5 includes an error code indicating a type of a generated command error, a generated time of the command error, and PC information, user information and a file name included in the data information. By carrying out the image output process of such an error report, the user can specify the type of the generated command error, and also the PC 105 and a user of a transmitter of the print data that caused the command error.

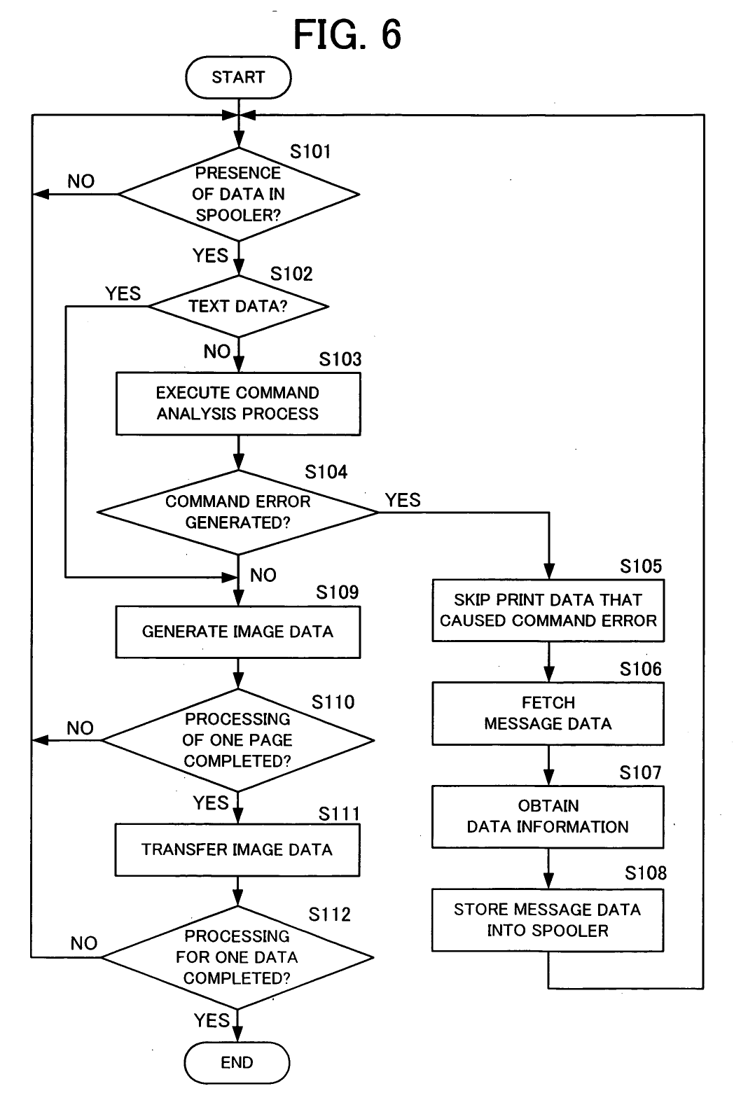

Next, a description will be made of an operation of the PCL controller 103 of the image forming device 200 described above. FIG. 6 is a flowchart illustrating an image processing procedure carried out by the PCL controller 103. Each process illustrated in the flowchart of FIG. 6 is executed by the control unit 130 of the PCL controller 103 in accordance with the control program stored previously in the ROM 131.

As described above, the image forming device 200 stores the print data and the text data to be processed, which have been received via the NIC unit 102 from the remote PCs 105 and 105 connected to the communication network N, into the spooler 134 of the PCL controller 103 via the device main body 101. The control unit 130 of the PCL controller 103 determines a presence or an absence of data (print data or text data) in the spooler 134, (step S101). When a determination of an absence of the data is made (step S101: NO), the control unit 130 goes on standby.

When the control unit 130 determines that the data exists in the spooler 134 (step S101: YES), the control unit 130 determines whether or not the data fetched from the spooler 134 is text data in accordance with whether or not a control command indicating that the data is print data is detected from a top of the fetched data (step S102). When the control unit 130 determines that the fetched data is the text data (step S102: YES), the flag relating to the print data is set OFF, and the command analysis process by the PCL analysis unit 135 is not carried out. The control unit 130 converts (renders) the text data fetched from the spooler 134 into image data (step S109). Then, the generated image data is stored sequentially into the page memory 136.

The control unit 130 determines whether or not the conversion process of the text data of one page stored in the spooler 134 into the image data has been completed (step S110). When the control unit 130 determines that the conversion process has not been completed (step S110: NO), the control unit 130 determines a presence or an absence of subsequent text data in the spooler 134 (step S101). When the control unit 130 determines that the text data exists in the spooler 134 (step S101: YES), the control unit 130 determines whether or not the data fetched from the spooler 134 is text data in accordance with the state of the flag relating to the print data (step S102). Here, since the flag relating to the print data is set OFF, the control unit 130 determines that the fetched data is the text data (step S102: YES). Without executing the command analysis process by the PCL analysis unit 135, the control unit 130 converts the text data fetched from the spooler 134 into the image data (step S109). The generated image data is stored sequentially into the page memory 136.

When the control unit 130 determines that the conversion process of the text data of one page stored in the spooler 134 into the image data has been completed (step S110: YES), the image data stored in the page memory 136 is transferred to the device main body 101 by the transfer control unit 137 (step S111). Then, the image data is stored into the DRAM 115. Furthermore, the control unit 130 determines whether or not the conversion process of the text data, as one print job stored in the spooler 134, into the image data has been completed (step S112). When the control unit 130 determines that the conversion process has not been completed (step S112: NO), the process returns to the process of step S101. Then, the processes of step S101 through step S111 are repeated.

Meanwhile, when the control unit 130 detects a control command, which indicates that data is print data, from a top of the data fetched from the spooler 134 and determines that the fetched data is the PCL format print data (step S102: NO), the flag relating to the print data is set ON. In addition, the print data stored in the spooler 134 is fetched per each command, and a command analysis process is executed on the fetched command by the PCL analysis unit 135 (step S103).

The control unit 130 determines whether or not a command error has generated in the command analysis process by the PCL analysis unit 135 (step S104). When a determination is made that the command error has generated (step S104: YES), the control unit 130 skips the print data that caused the command error (step S105). That is, for the print data stored in the spooler 134, the control unit 130 skips to last data of the print data (print job) that caused the command error. Therefore, the print data fetched from the spooler 134 next is print data relating to a next print job.

When the control unit 130 detects a generation of a command error, the control unit 130 fetches message data associated with an error code of the generated command error from the ROM 131 (step S106). In addition, the control unit 130 obtains data information of the print data that caused the command error from the RAM 112 of the device main body 101 (step S107). The control unit 130 adds an error generated time indicated by the clocking unit of the control unit 130 and the data information obtained from the device main body 101 to the message data fetched from the ROM 131. Then, the control unit 130 stores the message data into the spooler 134 (step S108), and the process returns to step S101.

As described above, the message data associated with the command error is stored in the spooler 134. Accordingly, an image output process of the error message shown in FIG. 5 can be carried out onto paper by the same processing as other data received via the communication network N and stored in the spooler 134.

Meanwhile, when the control unit 130 determines at step S104 that a command error has not generated (step S104: NO), in other words, when a command analysis process can be executed by the PCL analysis unit 135, the control unit 130 fetches the print data stored in the spooler 134 per each command. The command analysis process continues to be executed on the fetched command by the PCL analysis unit 135, and image data is generated (rendered) (step S109). Then, the generated image data is stored sequentially into the page memory 136. The control unit 130 determines whether or not the command analysis process for the print data of one page stored in the spooler 134 has been completed (step S110). When the control unit 130 determines that the command analysis process has not been completed (step S110: NO), the control unit 130 determines a presence or an absence of subsequent print data in the spooler 134 (step S101).

When the control unit 130 determines that subsequent print data exists in the spooler 134 (step S101: YES), the control unit 130 determines whether or not the data stored in the spooler 134 is text data in accordance with a state of the flag relating to the print data (step S102). Here, since the flag relating to the print data is set ON, the control unit 130 determines that the data is the print data (step S102: NO). The control unit 130 sequentially fetches each command of the print data stored in the spooler 134, and continues the command analysis process on the fetched command by the PCL analysis unit 135 (step S103).

When the control unit 130 determines that the command analysis process for the image data of one page stored in the spooler 134 has been completed (step S110: YES), the control unit 130 transfers the image data stored in the page memory 136 to the device main body 101 by the transfer control unit 137 (step S111). Then, the image data is stored into the DRAM 115. Furthermore, the control unit 130 determines whether or not the command analysis process for one print data (print job) stored in the spooler 134 has been completed (step S112). When the control unit 130 determines that the command analysis process has not been completed (step S112: NO), the process returns to step S101, and the processes of step S101 through step S111 are repeated.

When the control unit 130 determines that the conversion process of the text data, as one print job stored in the spooler 134, into the image data or the command analysis process for one print data stored in the spooler 134 has been completed (step S112: YES), the above-described process ends. Further, the control unit 110 of the device main body 101 sequentially transfers the image data, which has been transferred from the PCL controller 103 and stored in the DRAM 115, to the printer unit 104. Accordingly, the text data received via the communication network N or an image based on the print data, and an image based on the message data can be output onto paper.

In the above-described embodiment, a description is made of an example of a configuration in which the device main body 101, the NIC unit 102, the PCL controller 103 and the printer unit 104 of the image forming device 200 are provided on different substrates as shown in FIG. 4. However, the device main body 101, the NIC unit 102, the PCL controller 103 and the printer unit 104 of the image forming device 200 maybe provided on the same substrate. Moreover, the image data, which has been generated after the command analysis process carried out by the PCL controller 103, is stored once into the DRAM 115 of the device main body 101. Then, the image data is transferred sequentially to the printer unit 104. Since the image data is not transferred directly from the PCL controller 103 to the printer unit 104, even when the printer unit 104 is changed, the change of the printer unit 104 can be supported just by a change made in the device main body 101. As a result, an advantageous effect that the PCL controller 103 is not required to be changed can be obtained.

In the above-described embodiment, a description is made of a configuration in which the print data and the data information are received via the communication network N, and the received data information is stored into the RAM 112 of the device main body 101. However, for example, the data information can be described in a PJL written by a printer driver of the PC 105, and when the PJL is analyzed by the PCL controller 103, the data information can be obtained. In this case, for example, also for the print data received via another input port, such as a parallel port and a USB port, the data information of each print data can be obtained, and an error report with data information can be created.

What is claimed is:

1. An image forming device, comprising:
a receiving means for receiving print data and device information relating to a remote device from the remote device;
an image data generating means for generating image data from the print data received by the receiving means;
a forming means for forming an image based on the image data generated by the image data generating means onto a recording medium;
a detecting means for detecting a generation of a print error based on the print data received by the receiving means; and
an error information generating means for generating error information when the detecting means detects the generation of the print error, wherein the error information includes the device information received by the receiving means and information relating to the detected print error.

2. The image forming device according to claim 1, further comprising:
a device information storing means for storing the device information received by the receiving means; and
a deleting means for deleting, after the generating means generates the image data, device information corresponding to the print data, which has been used for generating the image data, from the device information storing means;
wherein when the detecting means detects the generation of the print error, the error information generating means generates error information including the device information stored in the device information storing means and information relating to the print error detected by the detecting means.

3. The image forming device according to claim 1, further comprising an image data storing means for storing the image data generated by the image data generating means;
wherein the forming means fetches the image data stored in the image data storing means from the image data storing means and forms an image based on the fetched image data.

4. The image forming device according to claim 1, wherein the image data generating means generates image data by executing a command analysis process on the print data received by the receiving means; and
when the image data generating means fails to execute the command analysis process, the detecting means determines that a print error has generated.

5. An image forming method, comprising:
a receiving step of receiving print data and device information relating to a remote device from the remote device;
an image data generating step of generating image data from the print data received at the receiving step;
a forming step of forming an image based on the image data generated at the image data generating step onto a recording medium;
a detecting step of detecting a generation of a print error based on the print data received at the receiving step; and
an error information generating step of generating error information when the generation of the print error is detected at the detecting step, wherein the error information includes the device information received at the receiving step and information relating to the print error detected at the detecting step.

6. The image forming method according to claim 5, further comprising:
a device information storing step of storing the device information received at the receiving step into a storage unit; and
a deleting step of deleting, after the image data is generated at the image data generating step, the device information corresponding to the print data, which has been used for generating the image data, from the storage unit;
wherein at the error information generating step, when the generation of the print error is detected at the detecting step, error information including the device information stored into the storage unit at the device information storing step and information relating to the print error detected at the detecting step is generated.

7. The image forming method according to claim 5, further comprising an image data storing step of storing the image data generated at the image data generating step into a data storage unit;
wherein at the forming step, the image data stored at the image data storing step is fetched from the data storage unit, and an image based on the fetched image data is formed.

8. The image forming method according to claim 5, wherein at the image data generating step, image data is generated by executing a command analysis process on the print data received at the receiving step; and
at the detecting step, when the command analysis process fails to be executed at the image data generating step, a determination is made that a print error has generated.

9. An image forming device, comprising:
a receiving means for receiving data having a command relating to an image forming process from a remote device;
a generating means for generating image data by analyzing the command included in the data received by the receiving means;
a forming means for forming an image based on the image data generated by the generating means onto a recording medium;
a detecting means for detecting a generation of a command error while the command is being analyzed by the generating means; and
a text data storing means for storing text data corresponding to each of a plurality of command errors;
wherein when the detecting means detects the generation of the command error, the forming means forms an image based on the text data stored in the text data storing means by being associated with the detected command error.

10. The image forming device according to claim 9, further comprising:
a data storing means for storing the data received by the receiving means; and
means for executing, when the detecting means detects the generation of the command error, a processing for storing text data corresponding to the detected command error into the data storing means;
wherein the generating means sequentially fetches the data stored in the data storing means, and generates image data from the fetched data.

11. The image forming device according to claim 10, wherein when the detecting means detects the generation of the command error, the generating means skips data relating to the command error stored in the data storing means.

12. The image forming device according to claim 10, wherein the means for executing executes a processing for storing text data corresponding to the command error detected by the detecting means into a top fetching area of the data storing means.

13. The image forming device according to claim 10, wherein the receiving means is configured to receive the data having the command and device information relating to the remote device, and
the image forming device further includes an adding means for adding, when the detecting means detects the generation of the command error, the device information received by the receiving means to text data corresponding to the detected command error; and
when the detecting means detects the generation of the command error, the means for executing executes a processing for storing the text data added with the device information by the adding means into the data storing means.

14. An image forming method, comprising:
a receiving step of receiving data having a command relating to an image forming process from a remote device;
a generating step of generating image data by analyzing the command included in the data received at the receiving step;
a forming step of forming an image based on the image data generated at the generating step onto a recording medium; and
a detecting step of detecting a generation of a command error while the command is being analyzed at the generating step;
wherein at the forming step, when the generation of the command error is detected at the detecting step, an image based on text data stored by being associated with the detected command error is formed.

15. The image forming method according to claim 14, further comprising:
a data storing step of storing data received at the receiving step; and
a step of executing, when the generation of the command error is detected at the detecting step, a processing for storing text data corresponding to the detected command error;
wherein at the generating step, the data stored at the data storing step and the data stored at the step of executing are fetched sequentially, and image data is generated from the fetched data.

16. The image forming method according to claim 15, wherein at the generating step, when the generation of the command error is detected at the detecting step, data relating to the command error is skipped.

17. The image forming method according to claim 15, wherein at the step of executing, text data corresponding to the command error detected at the detecting step is stored into a top fetching area.

18. The image forming method according to claim 15, wherein at the receiving step, the data having the command and device information relating to the remote device are received;
the image forming method further includes an adding step of adding, when the generation of the command error is detected at the detecting step, the device information received at the receiving step to text data corresponding to the detected command error; and
when the generation of the command error is detected at the detecting step, the step of executing executes a processing for storing the text data added with the device information at the adding step.
